(19) United States
(12) Patent Application Publication
(10) Pub. No.: US 2006/0098997 A1
(43) Pub. Date: May 11, 2006

(54) Method and apparatus for measuring color tone density of multipass color printer

(75) Inventors: Jin-Cheol Kim, Seoul (KR); Woo-Jung Shim, Suwon-si (KR); Jeong-Hwan Kim, Gunsan-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/156,564

(22) Filed: Jun. 21, 2005

(30) Foreign Application Priority Data
Nov. 11, 2004 (KR) 2004-0091909

(51) Int. Cl. G03G 15/00; G03G 15/08

(52) U.S. Cl. 399/49; 399/53

(57) ABSTRACT

A method and apparatus for measuring the color tone density of an image output from a multipass color printer consumes a minimum of time by using a test pattern that includes test patches for all of the developing units in the printer. The method includes developing a test pattern, which includes test patches for all developing units, on an organic photo conductor, measuring the color tone density of the developed test pattern, and adjusting developing variables according to the measured color tone density. Accordingly, it is possible to reduce the time required to measure the color tone density of an image output from a multipass color printer, using the test pattern.

### CROSS-REFERENCE TO RELATED PATENT APPLICATIONS

This application claims the benefit under 35 U.S.C. § 119(a) of Korean Patent Application No. 10-2004-0091909, filed on Nov. 11, 2004, in the Korean Intellectual Property Office, the entire disclosure of which is hereby incorporated by reference.

### BACKGROUND OF THE INVENTION

1. Field of the Invention

The present invention relates to a method and apparatus for measuring the color tone density of an image output from a multipass color printer. More particularly, the present invention relates to a method and apparatus for measuring the color tone densities of an image output from a multipass color printer with a minimum of time by using a test pattern including test patches for all of the developing units.

2. Description of the Related Art

In general, an electrophographic color printer includes an organic photo conductor (OPC), such as a photoreceptive drum or belt, a charging unit that charges the OPC, an exposing unit that exposes the charged OPC to light to selectively remove the charge of the OPC and form a latent electrostatic image of a predetermined pattern on the OPC, a developing unit that develops the latent electrostatic image by supplying a developing medium, such as toner, onto the latent electrostatic image, and a transferring device that transfers a developed image to a recording medium.

In general, the color tone densities of an image output from the electrophotographic color printer are determined by various factors, that is, ambient conditions such as temperature and humidity, age-related changes in elements such as the developing unit, and the voltage used in a developing process. Accordingly, the color tone densities of the image must be measured periodically, or at predetermined times, and the developing variables must be adjusted appropriately to maintain the color tone density at a constant level.

Conventionally, the color tone densities of an image are measured using the test patch shown in FIG. 1. FIG. 1 illustrates a conventional test patch of a color (such as, black) of toner contained in a developing unit. In the illustrated test patch, the color density is changed at several levels according to toner area coverage (TAC). TAC indicates the amount of toner transferred to an area. Referring to FIG. 1, the color density of the test patch is changed at eight levels 101 through 108. The eight levels 101 through 108 represent the color tone densities of the image, ranging from a dark area to a highlight area. Each of developing units of a conventional electrophotographic color printer has a particular test patch.

A conventional method of controlling the color tone densities of an image output from a multipass printer, such as a 4-pass color printer, will now be described. First, a test patch of a color, such as that shown in FIG. 1, of a developing unit is developed on an OPC. The color tone density of the developed test patch is measured by a color tone density (CTD) sensor. Next, in a like manner, the color tone density of the test patch of each of the other developing devices is measured. The developing variables are adjusted and the process is repeated until the measured color tone densities meet predetermined ending conditions.

In the conventional system described above, a 4-pass color printer must perform at least four passes to measure the color tone density of each of the colors of an image. Accordingly, it takes a significant amount of time to determine developing conditions and the first page output time (FPOT) is increased.

U.S. Pat. No. 6,185,386 discloses an image forming apparatus for forming a test patch of a color of an image, and is hereby incorporated by reference in its entirety.

Accordingly, there is a need for an improved method and apparatus for rapidly measuring and adjusting color tone density.

### SUMMARY OF THE INVENTION

An aspect of the present invention is to solve at least the above problems and/or disadvantages and to provide at least the advantages described below. Accordingly, an aspect of the present invention is to provide a method of measuring the color tone density of an image output from a multipass color printer with a minimum of time by using a test pattern that includes test patches for all of the developing units in the printer.

Another aspect of the present invention is to provide an apparatus for measuring the color tone density of an image output from a multipass color printer with a minimum of time, using a test pattern that includes test patches for all of the developing units in the printer.

According to one aspect of the present invention, a method of measuring the color tone density of an image output from a multipass electrophotographic color printer is provided. The method comprises developing a test pattern, which includes test patches for all developing units, on an organic photo conductor, measuring the color tone density of the developed test pattern, and adjusting developing variables according to the measured color tone density.

According to another aspect of the present invention, an apparatus for measuring the color tone density of an image output from a multipass electrophotographic color printer is provided. The apparatus comprises a developing device that develops a test pattern, which includes test patches for all developing units, on an organic photo conductor; a density measuring unit that measures the color tone density of an image produced by developing the test pattern; and a controller that controls developing variables according to the measured color tone density.

The test pattern preferably covers all of the colors of toner in the developing units, with the color tone density of each of the colors being changed at predetermined levels.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 illustrates a conventional test patch;

FIG. 2 is a flowchart of a method of measuring the color tone densities of an image output from a multipass color printer according to an embodiment of the present invention;

FIG. 3 is a block diagram of an apparatus for measuring the color tone densities of an image output from a multipass color printer according to an embodiment of the present invention;

FIG. 4 is a block diagram of a multipass electrophotographic color printer according to an embodiment of the present invention;

FIG. 5 illustrates a test pattern including test patches according to an embodiment of the present invention;

FIG. 6A is a diagram illustrating a process of developing a conventional test patch;

FIG. 6B is a diagram illustrating a process of developing a test patch according to an embodiment of the present invention;

FIG. 7A is a flowchart of a method of measuring the color tone density of a conventional test patch; and

FIG. 7B is a flowchart of a method of measuring the color tone density of a test patch according to an embodiment of the present invention.

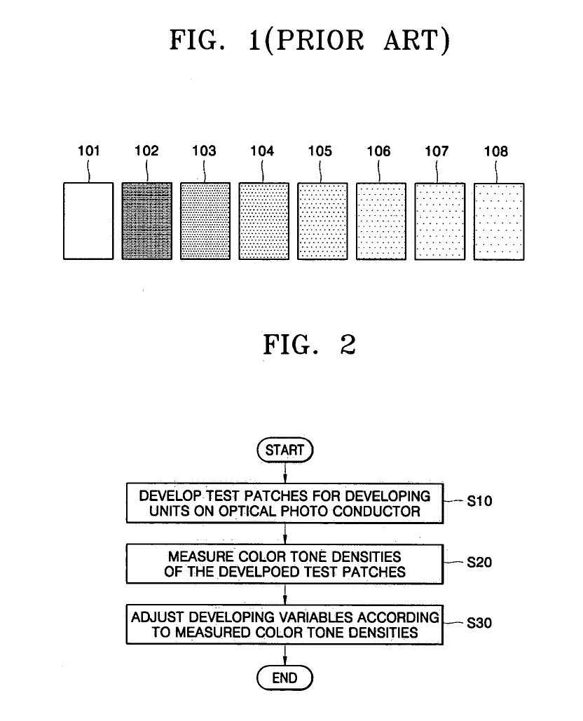

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 2 is a flowchart of a method of measuring the color tone densities of an image output from a multipass color printer according to an embodiment of the present invention. Referring to FIG. 2, a test pattern that includes test patches for developing units is developed on an organic photo conductor (OPC) (operation S 10). Next, the color tone densities of the colors in the developed test pattern are measured (operation S20), and developing variables are adjusted according to the measured color tone densities (operation S30).

In operation S20, the color tone densities of the colors in the test pattern developed on the OPC (or an intermediate transfer belt) may be measured by a color tone density (CTD) sensor.

The number of the developing units is preferably four, and the colors of toner in the developing units are preferably yellow (Y), magenta (M), cyan (C), and black (K), respectively.

Developing each of the test patches of the test pattern forms an image of the color of the toner in each of the developing units, with the toner density of the color changing at predetermined levels.

Operations S10 through S30 are repeated until predetermined ending conditions are satisfied. The predetermined ending conditions may include the number of times that the color tone densities of the colors are measured, or the deviation between each of the color tone densities and a reference color tone density.

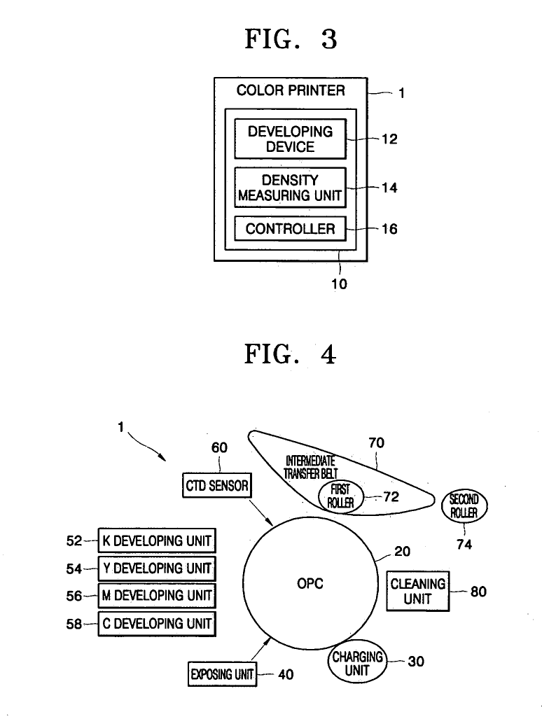

FIG. 3 is a block diagram of an apparatus 10 for measuring the color tone density of an image output from a multipass electrophotographic color printer 1 according to an embodiment of the present invention. The apparatus 10 includes a developing device 12 that develops a test pattern that includes test patches for the developing units (not shown), on an OPC (not shown), a density measuring unit 14 that measures the color tone density of an image formed by developing the test pattern, and a controller 16 that adjusts developing variables according to the measured color tone density.

Preferably, the density measuring unit 14 includes a CTD sensor (not shown), and measures the color tone density of the image formed by developing the test pattern on the OPC (or the intermediate transfer belt) using the CTD sensor.

The number of the developing units is preferably four, and the colors corresponding to the developing units are preferably yellow (Y), magenta (M), cyan (C), and black (K), respectively.

The developing of each of the test patches of the test pattern forms an image of the color of toner in each of the developing units, and the toner density of the color changes at predetermined levels.

The developing, measuring, and adjusting operations of the developing device 12, the density measuring unit 14, and the controller 16 are repeated until predetermined ending conditions are satisfied. The predetermined ending conditions may include the number of times that the color tone densities of the colors are measured, or a deviation between each of the color tone densities and a reference color tone density.

FIG. 4 is a block diagram of the multipass electrophotographic color printer 1 of FIG. 3. The printer 1 includes an OPC 20, a charging unit 30, an exposing unit 40, developing units 52 through 58, a CTD sensor 60, an intermediate transfer belt 70, and a cleaning unit 80.

The OPC 20 may be a photoreceptive drum or a photoreceptive belt. The charging unit 30 charges the OPC 20. The exposing unit 40 exposes the charged OPC 20 to light to selectively remove the charge of the charged OPC 20, and form a latent electrostatic image of a predetermined pattern.

The developing unit 52 is a black (K) developing unit, the developing unit 54 is a yellow (Y) developing unit, the developing unit 56 is a magenta (M) developing unit, and the developing unit 58 is a cyan (C) developing unit. The developing units 52 through 58 develop the exposed latent electrostatic image by supplying developing media, such as toner, onto the latent electrostatic image. The intermediate transfer belt 70 transfers the developed image onto a recording medium (not shown). The CTD sensor 60 is used to measure the color tone density of the image. The cleaning unit 80 removes remnant toner that is not transferred to the intermediate transfer belt 70.

In other words, the printer 1 forms art image by developing a latent electrostatic image by repeatedly supplying toners of various colors onto the latent electrostatic image according to a predetermined order. For instance, Y, M, C, and K toners are sequentially transferred onto the latent electrostatic image. Specifically, the OPC 20 is charged by the charging unit 30, and a latent electrostatic image is formed on the OPC 20 using the exposing unit 40. Next, an image of a single color is formed by applying a high developing voltage to one of the developing units 52 through 58 to move the toner to the OPC 20. The image of the single color is transferred onto the intermediate transfer belt 70 using a first roller 72 (first transfer). Remnant toner, which is not moved to the intermediate transfer belt 70, is removed by the cleaning unit 80. When all of four Y, M, C, and K images are transferred to the intermediate transfer belt 70, the images overlap with one another to form a full-color image. The overlapped images are transferred by a second roller 74 to the recording medium (second transfer).

The color tone density of an image output from the printer 1 may change due to various factors. For example, ambient conditions such as temperature and humidity, age-related changes in elements such as the developing units 52 through 58 of the printer 1, and the voltage used in a developing process all affect the color tone density. Accordingly, the color tone density must be constantly maintained by measuring the color tone density of an image periodically or at predetermined times and appropriately adjusting developing variables. For instance, the color tone density of an image can be measured whenever printing is performed on every 100th paper sheet or whenever the printer 1 is turned on.

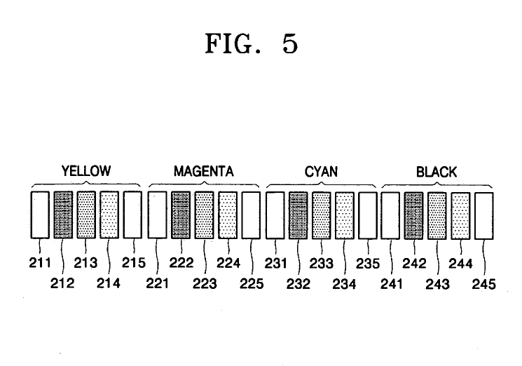

According to an embodiment of the present invention, the color tone density of an image is measured using a test pattern such as that shown in FIG. 5. Referring to FIG. 5, the test pattern includes test patches for all of the developing units. In a test patch, the color density of each color changes at several levels according to toner area coverage (TAC). The test pattern of FIG. 5 covers four colors,such as, Y, M, C, and K, the color density of each changing at five levels. The test pattern includes yellow areas 211 through 215, magenta areas 221 through 225, cyan areas 231 through 235, and black areas 241 through 245. TAC indicates the amount of toner transferred to an area. The areas of each of the four colors are representative of different parts of an image, ranging from a highlighted area to a dark area. As illustrated in FIG. 5, a test pattern according to the present invention includes test patches corresponding to the colors of toner in the developing units of a printer.

FIG. 5 illustrates a test pattern that covers four colors, with the color tone density of each color changing at five levels, according to an embodiment of the present invention. It should be recognized, of course, that the number of levels is not limited according to the present invention. For instance, it is possible to increase the number of the color tone density levels of each of the colors by reducing the widths of the areas of each color, within a range of color tone densities that the CTD sensor 60 can measure. The length of the test pattern of FIG. 5 is preferably determined such that an OPC performs a single pass to measure the color tone densities of all of colors. In conventional 4-pass printing, an OPC must perform four passes to measure the color tone densities of four colors, but the OPC performs one pass to measure the color tone densities of four colors according to the present invention. Accordingly, with the present invention, it is possible to reduce the time required to measure color tone densities, and reduce first page output time (FPOT).

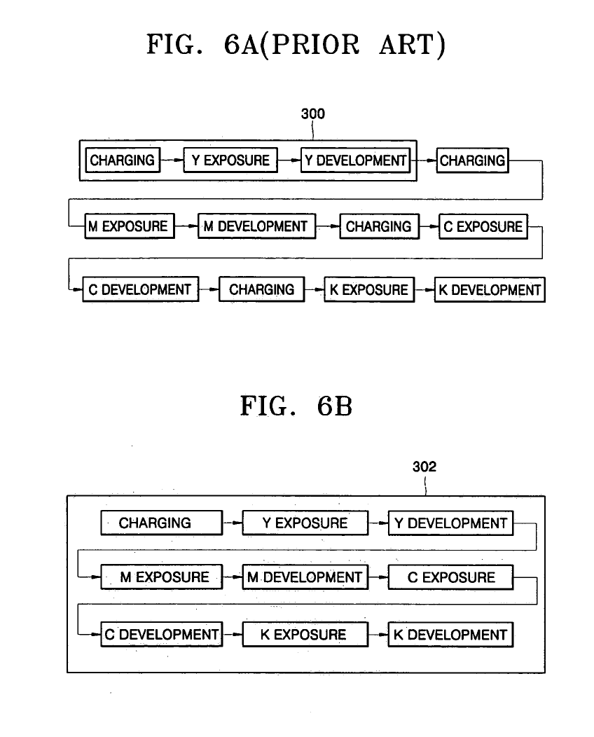

The times required to develop a conventional test patch and a test pattern according to an embodiment of the present invention will be compared with each other with reference to FIGS. 6A and 6B. FIG. 6A is a diagram illustrating a process of developing a conventional test patch, and FIG. 6B is a diagram illustrating a process 302 of developing a test pattern according to the present invention.

Referring to FIG. 6A, in 4-pass color printing, the color tone density of a yellow (Y) image is measured through charging, Y exposure, and Y development. The color tone density of magenta (M) is measured through charging, M exposure, and M development. The color tone density of cyan (C) is measured through charging, C exposure, and C development. Next, the color tone density of black (K) is measured through charging, K exposure, and K development. That is, four passes must be performed to measure the color tone densities of the four colors.

In contrast, referring to FIG. 6B, according to the present invention, the color tone densities of Y, M, C, and K are measured through charging, Y exposure, Y development, M exposure, M development, C exposure, C development, K exposure, and K development. That is, only one pass is required to measure the color tone densities of the four colors.

The time required to complete a process 300 of FIG. 6A is equal to that required to complete the process 302 of FIG. 6B. That is, it is possible to measure the color tone densities of four colors according to the present invention in the same time it takes to measure the color tone density of a single (Y) image using conventional 4-pass color printing.

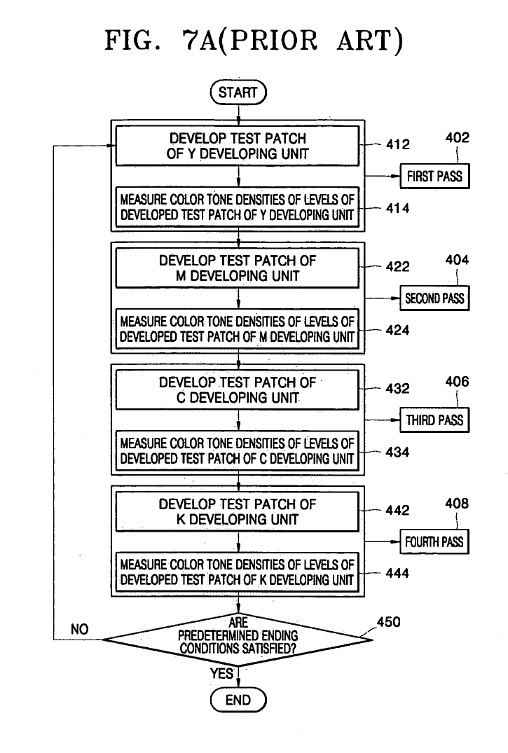

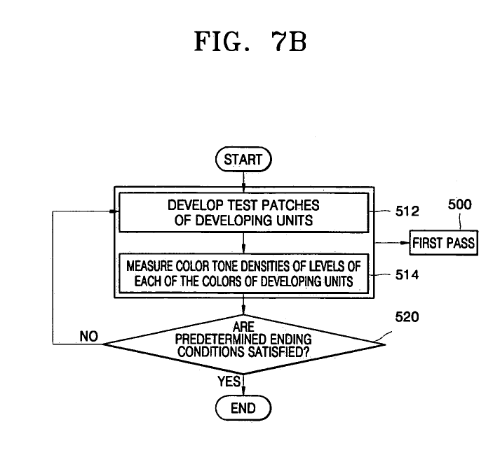

A method of measuring the color tone density of colors in a test patch will now be described with reference to FIGS. 7A and 7B. FIG. 7A is a flowchart illustrating a conventional method of measuring the color tone densities of colors, and FIG. 7B is a flowchart illustrating a method of measuring the color tone densities of colors in a test pattern according to an embodiment of the present invention.

In multipass color printing, such as, 4-pass color printing, the color tone density of an image may be measured by developing four colors in the sequence of Y, M, C, and K.

In the conventional method of FIG. 7A, a test patch of a Y developing unit is developed (operation 412). Next, the color tone density levels of the developed test patch of the Y developing unit are measured using the CTD sensor 60 of FIG. 4, the levels categorized according to TAC (operation 414). A first pass (or rotation) 402 of an OPC is performed to accomplish operations 412 and 414. TAC indicates the amount of toner transferred to an area. Next, a test patch for an M developing unit is developed (operation 422), and the color tone density levels of the developed test patch of the M developing unit are measured (operation 424). A second pass 404 is performed to accomplish operations 422 and 424. Next, a test patch for a C developing unit is developed (operation 432), and the color tone densities of levels of the developed test patch of the C developing unit are measured (operation 434). A third pass 406 is performed to accomplish operations 432 and 434. Next, a test patch of a K developing unit is developed (operation 442), and the color tone densities of levels of the developed test patch of the K developing unit are measured (operation 444). A fourth pass 408 is performed to accomplish operations 442 and 444.

Next, it is determined whether predetermined ending conditions are satisfied (operation 450). If the predetermined ending conditions are satisfied, the method of FIG. 7A is completed. If not, the developing variables are adjusted, and operations 412 through 444 are repeated.

In the method of FIG. 7B according to an embodiment of the present invention, a test pattern, such as that shown in FIG. 5, which includes test patches for all of the developing units, is developed (operation 512). Next, the color tone densities of levels of each of the colors are measured using the CTD sensor 60, the levels categorized according to TAC (operation 514). A first pass 500 is performed to accomplish operations 512 and 514. Accordingly, it is possible to measure the color tone densities of all of colors of developing units by performing only one pass according to the present invention.

To measure the color tone density of color using the CTD sensor 60, a light emitting unit of the CTD sensor 60 irradiates light onto the test pattern, and light reflected from the test patch is input to a light receiving unit of the CTD sensor 60. The intensity of the light input to the light receiving unit is determined by the color tone density of color in the test patch. The intensity of the light is transformed into an electrical signal and the color tone density is measured using the electrical signal.

Next, whether predetermined ending conditions are satisfied is determined (operation 520). If the predetermined ending conditions are satisfied, the method of FIG. 7B is terminated. If not, developing variables are adjusted and operations 512 through 520 are repeated. In other words, developing the test pattern and measuring the color tone density of the developed test pattern are repeated until the predetermined ending conditions are satisfied, and final developing conditions are determined.

The predetermined ending conditions may include various conditions. For instance, the ending conditions may include the number of times that the color tone densities are measured, or the deviation between each of the color tone densities and a reference color tone density. The number of times that the color tone densities are measured may be four or five.

As described above, according to the present invention, it is possible to reduce the time required to measure the color tone density of an image output from a multipass color printer, using a test pattern that includes test patches for all of the developing units.

In 4-pass printing, when using a conventional test patch, four passes of an OPC are required to measure the color tone densities of each of the colors of toner in the developing units. In contrast, when using a test pattern according to the present invention, only one pass of the OPC is required to measure the color tone densities of the colors in the test pattern, thereby reducing the first page output time (FPOT) to one fourth of the time required when the conventional test patch is used.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of measuring the color tone density of an image output from a multipass electrophotographic color printer, comprising:
(a) developing a test pattern, which includes test patches for a plurality of developing units, on an organic photo conductor;
(b) measuring the color tone density of the developed test pattern; and
(c) adjusting developing variables according to the measured color tone density.

2. The method of claim 1, wherein the step (b) comprises measuring the color tone density of an image of the developed test pattern, which is formed on the organic photo conductor, using a color tone density sensor.

3. The method of claim 1, wherein the number of the developing units is four, and the colors of toner in the developing units are yellow, magenta, cyan, and black.

4. The method of claim 1, wherein the step of developing a test pattern which includes test patches for the plurality of developing units produces images of the colors of toner in each of the developing units, the color tone density of the color changing at predetermined levels.

5. The method of claim 1, wherein the steps (a) through (c) are repeated until predetermined ending conditions are satisfied.

6. The method of claim 5, wherein the predetermined ending conditions include the number of times that the color tone density is measured, or a deviation between the color tone density and a reference color tone density.

7. An apparatus for measuring the color tone density of an image output from a multipass electrophotographic color printer, comprising:
a developing device that develops a test pattern, which includes test patches for all developing units, on an organic photo conductor;
a density measuring unit that measures the color tone density of an image produced by developing the test pattern; and
a controller that controls the developing variables according to the measured color tone density.

8. The apparatus of claim 7, wherein the density measuring unit comprises a color tone density sensor, and
the color tone density of the image, which is obtained by developing the test pattern on the organic photo conductor, is measured using the color tone density sensor.

9. The apparatus of claim 7, wherein the number of the developing units is four, and
the colors of toner in the developing units are yellow, magenta, cyan, and black.

10. The apparatus of claim 7, wherein developing the test pattern which includes test patches for a plurality of developing units produces images of the colors of toner in each of the developing units, the color tone density of the color changing at predetermined levels.

11. The apparatus of claim 7, wherein the operations of the developing device, the density measuring unit, and the controller are repeated until predetermined ending conditions are satisfied.

12. The apparatus of claim 11, wherein the predetermined ending conditions include the number of times that the color tone density is measured, or a deviation between the color tone density and a reference color tone density.

13. A method of adjusting the color tone density of an image output from a multipass electrophotographic color printer that includes a plurality of developing units, comprising:
(a) developing a test pattern that includes test patches for each of the plurality of developing units on an organic photo conductor;
(b) measuring the color tone density of the test patches;
(c) determining if predetermined ending conditions are satisfied; and
(d) if the predetermined ending conditions are not satisfied, adjusting developing variables according to the measured color tone density.

14. The method of claim 13, wherein steps (a)-(d) are repeated until the predetermined ending conditions are satisfied.

15. The method of claim 13, wherein step (c) includes determining if the number of times that the color tone density is measured has met a predetermined number.

16. The method of claim 15, wherein step (c) further includes determining if the deviation between the measured color tone density and a reference color tone density is within a predetermined limit.
